(19) United States
(12) Patent Application Publication
(10) Pub. No.: US 2025/0287479 A1
(43) Pub. Date: Sep. 11, 2025

(54) MICROWAVE HEAT PROCESSING APPARATUS

(71) Applicant: FORMOSA PLASTICS CORPORATION, Kaohsiung City (TW)

(72) Inventors: Hsien-Wen CHAO, Hsinchu (TW); Hung-Chun HSU, Hsinchu (TW); Yan-Cheng CHEN, Hsinchu (TW); Tsun-Hsu CHANG, Hsinchu (TW); Sheng-Shiun LIN, Kaohsiung City (TW); Chia-Chi HUNG, Kaohsiung City (TW); Ching-Cheng CHUNG, Kaohsiung City (TW); Long-Tyan HWANG, Kaohsiung City (TW); Shih-Hau GUAN, Kaohsiung City (TW)

(21) Appl. No.: 18/663,848

(22) Filed: May 14, 2024

(30) Foreign Application Priority Data
Mar. 5, 2024 (TW) 113202188

(51) Int. Cl. H05B 6/70; H05B 6/80

(52) U.S. Cl. CPC H05B 6/707; H05B 6/80

(57) ABSTRACT

A microwave heat processing apparatus is provided. The microwave heat processing apparatus includes a microwave chamber and a microwave source. The microwave chamber is configured to heat up a thread type object and includes a primary waveguide tube and a microwave absorber. The primary waveguide tube is configured to accommodate the thread type object, in which a tube wall of the primary waveguide tube has an auxiliary opening and a center extension direction does not pass through the auxiliary opening. The microwave absorber is in the primary waveguide tube. The microwave source connects to the primary waveguide tube.

### CROSS-REFERENCE TO RELATED APPLICATION

This application claims priority to Taiwan Application Serial Number 113202188, filed Mar. 5, 2024, which is herein incorporated by reference in its entirety.

### BACKGROUND

### Field of Invention

The present disclosure relates to a microwave heat processing apparatus. In particular, the present disclosure relates to a microwave heat processing apparatus including a microwave absorber.

### Description of Related Art

Currently, exited apparatus can perform heat processing on the thread-type objects by using a method of a standing wave or a traveling wave. The method of the standing wave has a smaller and more concentrated heating range and is unable to uniformly heat the thread-type objects. The method of the traveling wave has a larger heating range but the final temperatures of the thread-type objects may be different due to the different microwave-absorption rates of the thread-type objects.

### SUMMARY

According to some embodiments of the present disclosure, a microwave heat processing apparatus is provided. A particular arrangement structure of the microwave absorber is disposed in the microwave heat processing apparatus. The arrangement structure of the microwave absorber has a high temperature stability and extraordinary thermal conductivity. The thread-type object may be heated by absorbing the traveling wave produced by a microwave source and further heated by the microwave absorber. Thus, the present disclosure may achieve a uniform heating during the microwave-heat processing thereby accomplishing a high efficiency, stable and uniform heat processing.

According to some embodiments of the present disclosure, a microwave heat processing apparatus is provided. The microwave heat processing apparatus includes a microwave chamber and a microwave source. The microwave chamber is configured to heat the thread-type object and includes a primary waveguide tube and a microwave absorber. The primary waveguide tube is configured to accommodate the thread-type object, in which a tube wall of the primary waveguide tube has an auxiliary opening and the center extending direction of the primary waveguide tube dose not pass through the auxiliary opening. The microwave absorber is in the primary waveguide tube. The microwave source is connected to the primary waveguide tube.

According to an embodiment of the present disclosure, the microwave heat processing apparatus is described above, in which the primary waveguide tube further includes a first opening and a second opening and the center extending direction of the primary waveguide tube passes through the first opening and the second opening.

According to an embodiment of the present disclosure, the microwave heat processing apparatus is described above, in which a plane where the auxiliary opening is located intersects a plane where the first opening is located.

According to an embodiment of the present disclosure, the microwave heat processing apparatus is described above, in which the tube wall of the primary waveguide tube further has a cooling opening, and a size of the auxiliary opening is greater than a size of the cooling opening.

According to an embodiment of the present disclosure, the microwave heat processing apparatus is described above, in which the primary waveguide tube has a first portion and a second portion, and the first portion of the primary waveguide tube is closer to the microwave source than the second portion of the primary waveguide tube, and the cooling opening is disposed at the first portion of the primary waveguide tube.

According to an embodiment of the present disclosure, the microwave heat processing apparatus is described above, in which a plurality of auxiliary openings are symmetrically disposed with respect to the center extending direction of the primary waveguide tube.

According to an embodiment of the present disclosure, the microwave heat processing apparatus is described above, in which an extending direction of the auxiliary openings is parallel with the center extending direction of the primary waveguide tube.

According to an embodiment of the present disclosure, the microwave heat processing apparatus is described above further includes a microwave baffle that covers the auxiliary openings.

According to an embodiment of the present disclosure, the microwave heat processing apparatus is described above, in which the microwave chamber further comprises an auxiliary waveguide tube connected between the primary waveguide tube and the microwave source, wherein the microwave source deviates from the center extending direction of the primary waveguide tube.

According to an embodiment of the present disclosure, the microwave heat processing apparatus is described above, in which the auxiliary waveguide tube has a discharge opening, and the center extending direction of the primary waveguide tube passes through the discharge opening.

According to an embodiment of the present disclosure, the microwave heat processing apparatus is described above, in which a size of the auxiliary opening is greater than a size of the microwave absorber.

According to an embodiment of the present disclosure, the microwave heat processing apparatus is described above, in which a length of the auxiliary opening is greater than a length of the microwave absorber.

According to an embodiment of the present disclosure, the microwave heat processing apparatus is described above, in which the microwave absorber forms a heating chamber inside the primary waveguide tube.

According to an embodiment of the present disclosure, the microwave heat processing apparatus is described above, in which the center extending direction of the primary waveguide tube passes through the heating chamber.

According to some embodiments of the present disclosure, a microwave heat processing apparatus is provided. The microwave heat processing apparatus includes a microwave chamber and a microwave source. The microwave chamber is configured to heat a thread-type object and includes a primary waveguide tube, a first auxiliary opening and a second auxiliary opening. The primary waveguide tube is configured to accommodate the thread-type object. The first auxiliary opening is on a first tube wall of the primary waveguide tube. The second auxiliary opening is on a second tube wall of the primary waveguide tube opposite to the first tube wall, in which a center extending direction of the primary waveguide tube does not pass through the first and second auxiliary openings. The microwave absorber is in the primary waveguide tube. The microwave source is connected to the primary waveguide tube.

### BRIEF DESCRIPTION OF THE DRAWINGS

FIG. 1 is a top view of the microwave heat processing apparatus in accordance with some embodiments of the present disclosure.

FIG. 2A is a stereoscopic schematic view of the microwave chamber of the microwave heat processing apparatus in accordance with some embodiments of the present disclosure.

FIG. 2B is a top view of the microwave chamber of the microwave heat processing apparatus in accordance with some embodiments of the present disclosure.

FIG. 2C is a side view of the microwave chamber of the microwave heat processing apparatus in accordance with some embodiments of the present disclosure.

FIG. 3A is a stereoscopic schematic view of the primary waveguide tube of the microwave heat processing apparatus in accordance with some embodiments of the present disclosure.

FIG. 3B is a stereoscopic schematic view of the primary waveguide tube of the microwave heat processing apparatus in accordance with some embodiments of the present disclosure.

FIG. 3C is a stereoscopic schematic view of the primary waveguide tube of the microwave heat processing apparatus in accordance with some embodiments of the present disclosure.

FIG. 3D is a stereoscopic schematic view of the primary waveguide tube of the microwave heat processing apparatus in accordance with some embodiments of the present disclosure.

FIG. 4 is a stereoscopic schematic view of the microwave heat processing apparatus installed on a driving device, which uses the arrangements of the microwave absorber to achieve the heat processing in accordance with some embodiments of the present disclosure.

### DETAILED DESCRIPTION

Reference will now be made in detail to the present embodiments of the disclosure. However, it should be understand that the embodiments of the disclosure provide many practicable concepts for implementing in various subject matters. The embodiments discussed and disclosed herein are for the illustration only, and are not intended to limit the scope of the disclosure. The term “first” and “second” used herein do not indicate specific order or sequence, but are only used to distinguish the units or operations described in same technical terms.

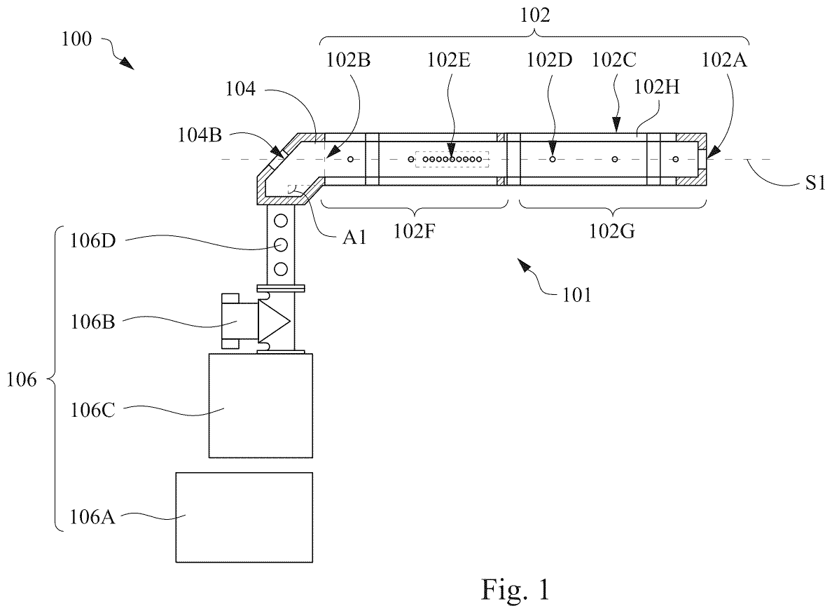

FIG. 1 is a top view of the microwave heat processing apparatus 100 in accordance with some embodiments of the present disclosure. In some embodiments, the microwave heat processing apparatus includes a microwave chamber 101 and a microwave source 106. The microwave chamber 101 includes a primary waveguide tube 102 and an auxiliary waveguide tube 104.

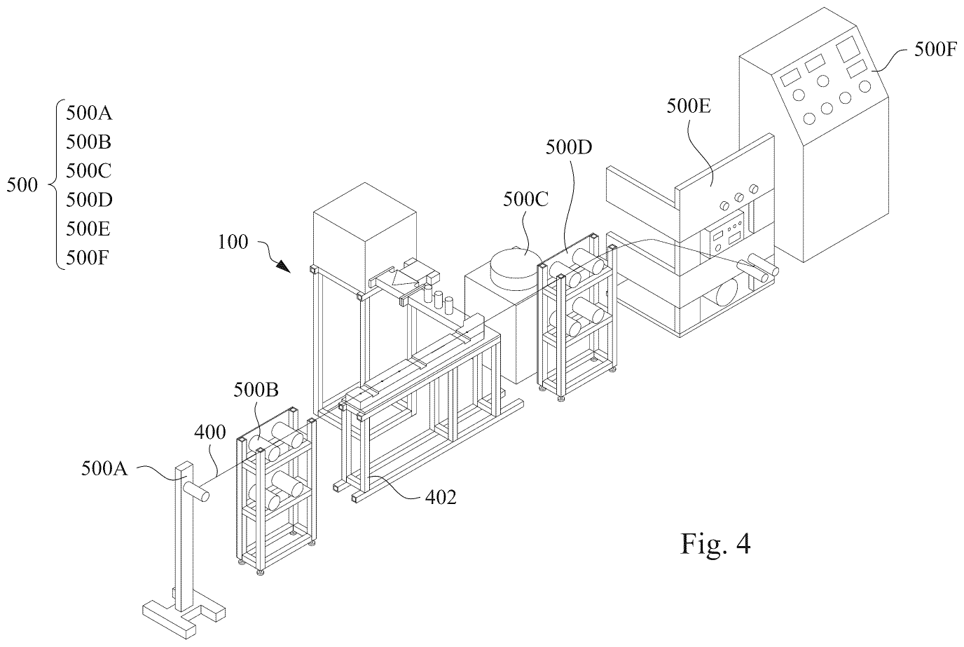

As shown in FIG. 1, in the present embodiment, the primary waveguide tube 102 is configured to accommodate a thread-type object 400 (please refer to the following FIG. 4). The primary waveguide tube 102 further includes a first opening 102A and a second opening 102B. A center extending direction S1 of the primary waveguide tube 102 passes through the first opening 102A and the second opening 102B, and a plane where the first opening 102A is located is substantially in parallel with a plane where the second opening 102B is located. The tube wall 102H of the primary waveguide tube 102 has at least one auxiliary opening 102C and the center extending direction S1 of the primary waveguide tube 102 does not pass through the auxiliary opening 102C. These auxiliary openings 102C are symmetrically disposed along the center extending direction S1 of the primary waveguide tube 102 and the extending direction of the auxiliary openings 102C is parallel with the center extending direction S1 of the primary waveguide tube 102. In other embodiments, the auxiliary openings 102C may be disposed unsymmetrically. The plane where the auxiliary opening 102C is located may intersect the plane where the first opening 102A is located and the plane where the second opening 102B is located, for example, perpendicularly.

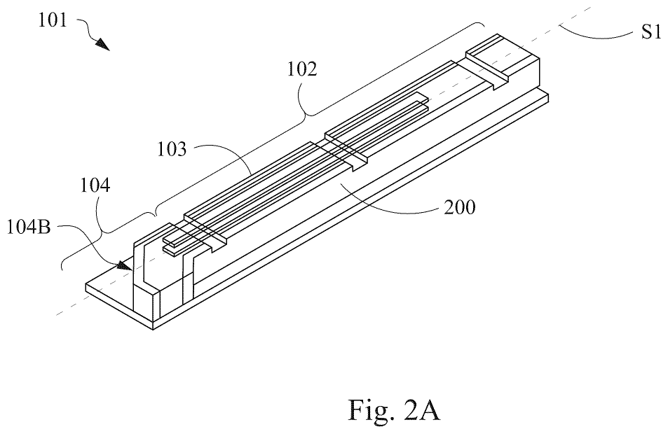

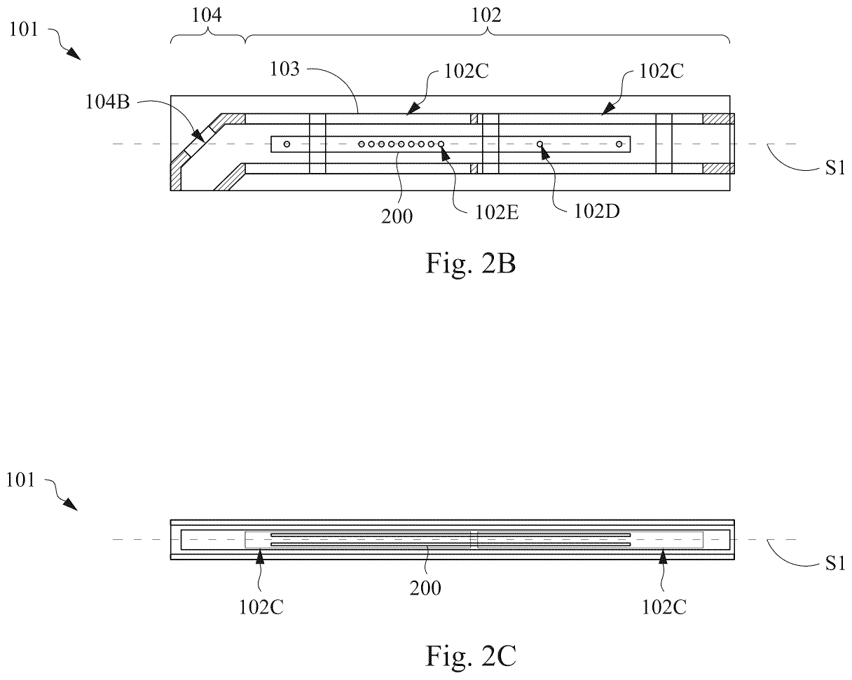

In the present embodiment, the primary waveguide tube 102 further includes functional openings 102D. The functional openings 102D may be adjusted to the different functional openings according to different process requirements. For example, in some embodiments, multiple functional openings 102D may be disposed on the primary waveguide tube 102, in which the functional openings 102D may serve as observation windows of the primary waveguide tube 102. The functional openings 102D may monitor a temperature of a microwave absorber 200 (please refer to the following FIG. 2A to 2C) during the microwave process. This design may adjust the microwave temperature in real time to heat the thread-type object 400 evenly. For example, in another embodiment, the functional openings 102D may serve as the gas filling openings. The functional openings 102D may be filled with gases of different temperatures according to the process requirements to facilitate different processing process for the thread-type object 400. The number and the opening positions of the functional openings 102D may be adjusted according to the functional or process requirements, but the opening size of the functional opening 102D have to be below a certain size to prevent the microwave from leaking. It should be noticed that these examples should not limit the scope of the present embodiment.

In addition, in some embodiments, the tube wall 102H of the primary waveguide tube 102 has a cooling opening 102E, and the size of the auxiliary opening 102C is larger than the size of the cooling opening 102E. The cooling opening 102E may allow air to enter or to be exhausted to facilitate the control of the temperature of the primary waveguide tube 102. The number and the opening position of the cooling opening 102E may be adjusted according to the functional or process requirements, but the size of the cooling opening 102E have to be below a certain size to prevent the microwave from leaking. It should be noticed that these examples should not limit the scope of the embodiment.

Referring back to FIG. 1, in the present embodiment, the primary waveguide tube 102 has a first portion 102F and a second portion 102G, and the first portion 102F of the primary waveguide tube 102 is closer to the microwave source 106 than the second portion 102G of the primary waveguide tube 102, in which the cooling opening 102E is disposed on the first portion 102F of the primary waveguide tube 102. In some embodiments, the temperature of the first portion 102F is between the microwave source 106 and the second portion 102G. In other words, the temperature of the first portion 102F may be higher than the temperature of the second portion 102G, so that the thread-type object 400 may be first heated at a low temperature and then be heated at a high temperature. The temperatures of the first portion 102F and the second portion 102G may be adjusted according to the functional and process requirements. For example, in some embodiments, according to the process requirements, the thread-type object 400 need to be first heated at a high temperature and then further be heated at a low temperature. Thus, the temperature of the first portion 102F may be adjusted to be higher than the temperature of the second portion 102G. The control of the temperature section may be accomplished by the cooling opening 102E or other shape configurations.

In the present embodiment, the microwave chamber 101 further includes an auxiliary waveguide tube 104, in which the auxiliary waveguide tube 104 has a discharge opening 104B. The auxiliary waveguide tube 104 is connected between the primary waveguide tube 102 and the microwave source 106 with a curve angle A1, in which the microwave source 106 deviates from the center extending direction S1 of the primary waveguide tube 102. The curve angle A1 may be adjusted according to the functional or process requirements. For example, in the present embodiment, the curve angle A1 is 90 degree to facilitate the center extending direction S1 of the primary waveguide tube 102 passing the discharge opening 104B. Thus, the discharge opening 104B may be coaxial (e.g., substantially parallel) with the first opening 102A and the second opening 102B. This design may decrease the bending number of the thread-type object 400, thereby keeping the thread-type object 400 substantially horizontal and achieving a uniform heating performance. It should be noticed that these examples should not limit the scope of the embodiment.

The microwave source 106 is coupled to the primary waveguide tube 102 through the auxiliary waveguide tube 104. The microwave source 106 is configured to generate the quasi-traveling wave, and to transmit the quasi-traveling to the primary waveguide tube 102 by the auxiliary waveguide tube 104, thus heating the thread-type object 400 (please refer to the following FIG. 4) in the primary waveguide tube 102. In some embodiments, the primary waveguide tube 102 and the auxiliary waveguide tube 104 include wave-non-absorbing metallic materials, e.g., aluminum. This design may limit the microwave inside the primary waveguide tube 102 and the auxiliary waveguide tube 104 to increase the heating efficiency.

FIG. 2A is a stereoscopic schematic view of the microwave chamber 101 of the microwave heat processing apparatus in accordance with some embodiments of the present disclosure. FIG. 2B is the top view of FIG. 2A. FIG. 2C is the side view of FIG. 2A. Please refer to FIG. 1, FIG. 2A, FIG. 2B, and FIG. 2C. In some embodiments, the microwave absorber 200 is in the primary waveguide tube 102 and configured to absorb the quasi-traveling wave. The microwave absorb includes a lossy material with a loss tangent greater than 0.01. The lossy material may be a high temperature resistant and wave-absorbing material which may transfer the loss of the electrical magnetic wave in the medium into thermal energy, such as silicon carbide (SiC), silicon nitride (Si₃N₄), the compounds of SiC and Si₃N₄, other suitable material, or the combination thereof.

In the present embodiment, the microwave absorber 200 is substantially parallelly disposed in the primary waveguide tube 102. A space may be formed between the microwave absorbers 200 to pass the thread-type object 400, thereby further heating the thread-type object 400. It should be noticed that these examples should not limit the scope of the embodiment. The number, shapes and arrangements of the microwave absorber 200 may be adjusted according to the functional and process requirements.

In some embodiments, the microwave absorber 200 may be disposed in the first portion 102F and the second portion 102G of the primary waveguide tube 102 by the auxiliary opening 102C. The microwave chamber 101 further includes a removable microwave baffle 103 which is configured to cover the auxiliary opening 102C. The microwave baffle 103 may prevent the microwave from leaking and make the microwave absorber 200 easy to replace. This design increases the convenience and the variation of the microwave process.

As shown in FIG. 1, in some embodiments, the microwave source 106 further includes a power source 106A, a protection device 106B, a microwave generator 106C and a controller 106D.

In some embodiments, the power source 106A is configured to provide the energy required by the microwave source 106. The microwave generator 106C is electrically connected to the power source 106A and configured to generate the microwave required by the heat process. The type of the microwave generated by the microwave generator 106C may be adjusted according to functional and process requirements. For example, in the present embodiment, the microwave generator generates the quasi-traveling wave with 2.45 GHZ according to the structure of the microwave chamber 101. The quasi-traveling wave may not create hot spots inside the microwave chamber 101, such that the thread-type object 400 can be heated evenly. It should be noticed that these examples should not limit the scope of the embodiment.

In some embodiments, the protection device 106B is connected to the microwave generator 106C. For example, in some embodiments, the protection device 106B connects the cool water device 500C (please refer to following FIG. 4) and may guide the reflected microwave, that may damage the microwave generator 106C, into cool water device 500C. In addition, the cool water device 500C may keep the microwave generator 106C at certain working temperature. It should be noticed that these examples should not limit the scope of the embodiment.

In some embodiments, the controller 106D is connected to the protection device 106B and is configured to adjust the quasi-traveling wave. The control 106D may control the loss of the quasi-traveling wave inside the microwave chamber. For example, in some embodiments, the controller 106D may be an impedance matching device and adjust the feature of the quasi-traveling by the depth of the knobs of the controller 106D, e.g., power, to optimize the heat efficiency of the quasi-traveling.

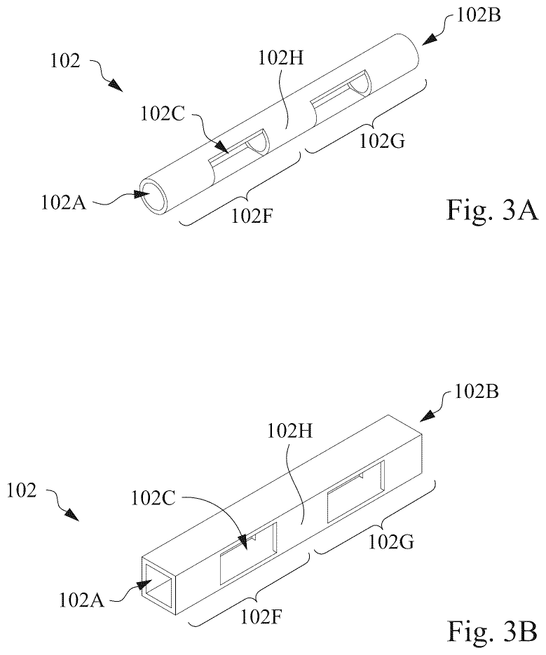

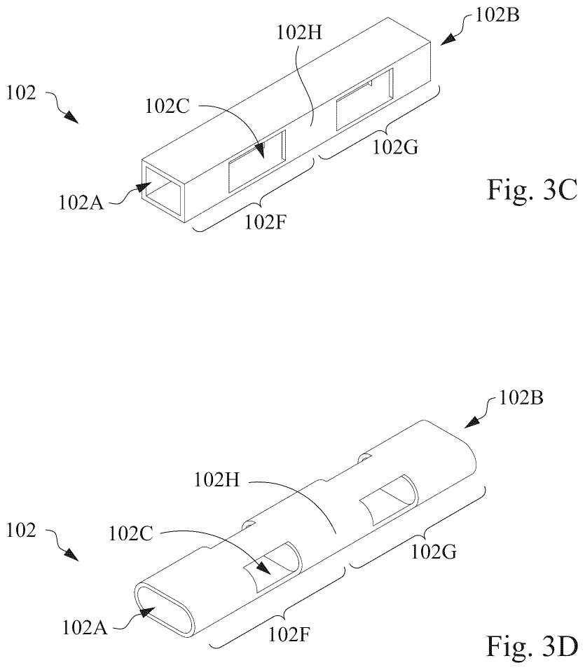

FIG. 3A to FIG. 3D is a stereoscopic schematic view of the primary waveguide tube 102 of the microwave heat processing apparatus 100 in accordance with some embodiments of the present disclosure. Please refer to FIG. 3A to FIG. 3D. The shapes of the primary waveguide tube 102 may be adjusted according to the functional and process requirements. For example, in some embodiments, the shapes of the primary waveguide tube 102 may be circle, square, rectangle and ellipse or any shapes that the thread-type object 400 may pass through. The number and shapes of the openings of the primary waveguide tube 102 may be adjusted according to the functional and the process requirements. For example, in some embodiments, the shapes of the first opening 102A and the second opening 102B may be circle (refer to FIG. 3A), square (refer to FIG. 3B), rectangle (refer to FIG. 3C) or the combination thereof (refer to FIG. 3D), etc. In addition, in some embodiments, the tube wall 102H of the primary waveguide tube 102 may have multiple auxiliary openings 102C. The opening positions, number, sizes and shapes of the auxiliary openings 102C may be adjusted according to the functional and the process requirements. For example, in the present embodiment, multiple auxiliary openings are disposed at the lateral sides of the first portion 102F or the lateral sides of the second portion 102G.

With this design, it may be convenience to adjust the number and arrangements of the microwave absorber 200. The number, shapes and the arrangements of the microwave absorber 200 may be adjusted according to the functional and the process requirements. For example, in some embodiments, multiple microwave absorbers 200 may be disposed integrally or separately in the primary waveguide tube 102 to form a heating chamber at a single temperature or multiple heating chambers at different temperature. For example, in some embodiments, multiple microwave absorbers 200 may be disposed in the primary waveguide tube 102 through the auxiliary openings 102C and increase the heat efficiency to the thread-type object 400 according to the functional and the process requirements. In addition, microwave absorbers 200 may be circle, square, rectangle and ellipse or any shapes that the thread-type object 400 may pass through.

FIG. 4 is a stereoscopic schematic view of the microwave heat processing apparatus installed on a driving device 500, which uses the arrangements of the microwave absorber to achieve the heat processing in accordance with some embodiments of the present disclosure. Please refer to the FIG. 4. The driving device 500 includes a guide-line frame 500A, a front tension machine 500B, a cool water device 500C, a back tension machine 500D, a winding machine 500E and a control platform 500F.

As shown in FIG. 4, the microwave heat processing apparatus 100 is placed on the stand 402, and the thread-type object 400 passes the microwave heat processing apparatus 100 at a uniform speed by the guide-line frame 500A, the front tension machine 500B, the back tension machine 500D, and the winding machine 500E. The thread-type object 400 may be heated in the microwave heat processing apparatus 100 at a uniform speed by the driving device 500. During the heat process, the moving speed may be controlled by the control platform 500F according to the process requirements. In addition, the thread-type object 400 may be fibers, silks, man-made fibers or man-made silks that the thread-type object 400 may pass through. It should be noticed that these examples should not limit the scope of the embodiment.

According to some embodiments of the present disclosure, a microwave heat processing apparatus is provided. A particular arrangement structure of the microwave absorber is disposed in the microwave heat processing apparatus. The arrangement structure of the microwave absorber has a high temperature stability and extraordinary thermal conductivity. The thread-type object may be heated by absorbing the traveling wave produced by a microwave source and further heated by the microwave absorber. Thus, the present disclosure may achieve a uniform heating during the microwave-heat processing thereby accomplishing a high efficiency, stable and uniform heat processing.

Although several embodiments of the disclosure are described above, it is not intended to limit this disclosure. Those skilled in the art may use the present disclosure as a basis for designing or modifying other processes and structures for carrying out the same purposes and/or achieving the same advantages of the embodiments introduced herein without difficulty. Those skilled in the art should also realize that they may make various changes, substitutions, and alterations herein without departing from the spirit and scope of the present disclosure.

What is claimed is:

1. A microwave heat processing apparatus, comprising:
a microwave chamber configured to heat a thread-type object, comprising;
a primary waveguide tube configured to accommodate the thread-type object, wherein a tube wall of the primary waveguide tube has an auxiliary opening, and a center extending direction of the primary waveguide tube does not pass through the auxiliary opening; and
a microwave absorber in the primary waveguide tube; and
a microwave source connected to the primary waveguide tube.

2. The microwave heat processing apparatus of claim 1, wherein the primary waveguide tube further includes a first opening and a second opening and the center extending direction of the primary waveguide tube passes through the first opening and the second opening.

3. The microwave heat processing apparatus of claim 2, wherein a plane where the auxiliary opening is located intersects a plane where the first opening is located.

4. The microwave heat processing apparatus of claim 1, wherein the tube wall of the primary waveguide tube further has a cooling opening, and a size of the auxiliary opening is greater than a size of the cooling opening.

5. The microwave heat processing apparatus of claim 4, wherein the primary waveguide tube has a first portion and a second portion, and the first portion of the primary waveguide tube is closer to the microwave source than the second portion of the primary waveguide tube, and the cooling opening is disposed at the first portion of the primary waveguide tube.

6. The microwave heat processing apparatus of claim 1, wherein a plurality of auxiliary openings are symmetrically disposed with respect to the center extending direction of the primary waveguide tube.

7. The microwave heat processing apparatus of claim 1, wherein an extending direction of the auxiliary openings is parallel with the center extending direction of the primary waveguide tube.

8. The microwave heat processing apparatus of claim 1, further comprising:
a microwave baffle covering the auxiliary openings.

9. The microwave heat processing apparatus of claim 1, wherein the microwave chamber further comprises an auxiliary waveguide tube connected between the primary waveguide tube and the microwave source, wherein the microwave source deviates from the center extending direction of the primary waveguide tube.

10. The microwave heat processing apparatus of claim 9, wherein the auxiliary waveguide tube has a discharge opening, and the center extending direction of the primary waveguide tube passes through the discharge opening.

11. The microwave heat processing apparatus of claim 1, wherein a size of the auxiliary opening is greater than a size of the microwave absorber.

12. The microwave heat processing apparatus of claim 1, wherein a length of the auxiliary opening is greater than a length of the microwave absorber.

13. The microwave heat processing apparatus of claim 1, wherein the microwave absorber forms a heating chamber inside the primary waveguide tube.

14. The microwave heat processing apparatus of claim 13, wherein the center extending direction of the primary waveguide tube passes through the heating chamber.

15. A microwave heat processing apparatus, comprising:
a microwave chamber configured to heat a thread-type object, comprising;
a primary waveguide tube configured to accommodate the thread-type object;
a first auxiliary opening on a first tube wall of the primary waveguide tube;
a second auxiliary opening on a second tube wall of the primary waveguide tube opposite to the first tube wall, wherein a center extending direction of the primary waveguide tube does not pass through the first and second auxiliary openings; and
a microwave absorber in the primary waveguide tube; and
a microwave source connected to the primary waveguide tube.
